(19) United States
(12) Patent Application Publication
(10) Pub. No.: US 2014/0320539 A1
(43) Pub. Date: Oct. 30, 2014

(54) SEMANTIC ZOOM-IN OR DRILL-DOWN IN A VISUALIZATION HAVING CELLS WITH SCALE ENLARGEMENT AND CELL POSITION ADJUSTMENT

(71) Applicant: HEWLETT- PACKARD DEVELOPMENT COMPANY, L. P., Houston, TX (US)

(72) Inventors: Ming C. Hao, Palo Alto, CA (US); Sebastian Mittelstaedt, Konstanz (DE); Umeshwar Dayal, Saratoga, CA (US); Meichun Hsu, Los Altos Hills, CA (US); Daniel Keim, Steisslingen (DE)

(73) Assignee: HEWLETT-PACKARD DEVELOPMENT COMPANY, L.P., Houston, TX (US)

(21) Appl. No.: 13/873,673

(22) Filed: Apr. 30, 2013

(51) Int. Cl. G09G 5/373

(52) U.S. Cl. CPC G09G 5/373
USPC 345/661

(57) ABSTRACT

A region is selected in a visualization that displays cells representing respective events, the cells being depicted in the visualization according to a first group of attributes of the events, where the region corresponds to a subset of the events. In response to detecting a first type of input provided with respect to the region, a semantic zoom-in visualization of the region is generated, the semantic zoom-in visualization depicting the cells representing the events of the subset at an enlarged scale and according to the first group of attributes and at a higher resolution to show further information relating to the events of the subset. In response to detecting a second type of input provided with respect to the region, a semantic drill-down visualization of the region is generated, the semantic drill-down visualization visualizing the events of the subset at an enlarged scale and according to a second group of attributes having at least one attribute that differs from the attributes of the first group. Generating the semantic zoom-in visualization or the semantic drill-down visualization includes adjusting positions of cells sharing common attribute values.

### BACKGROUND

With traditional techniques of visualizing attributes (or variables) of data records, it can be difficult to understand the relationship of the attributes. There can be a relatively large number of data records, and certain attributes of the data records can be associated with a relatively large number of values. When a relatively large amount of information is to be visualized, the result can be a cluttered visualization where users have difficulty in understanding the visualized information.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments are described with respect to the following figures:

FIG. 1 is a graphical view of an example visualization screen that depicts cells representing events, in accordance with some implementations;

FIG. 2 is a flow diagram of a visualization process, in accordance with some implementations;

FIGS. 3-5 are graphical views of semantic focused visualizations according to some implementations; and

FIG. 6 is a block diagram of a system that is able to incorporate some implementations.

### DETAILED DESCRIPTION

Large amounts of data may not be effectively visualized in a traditional graphical visualization. There can be relatively large amounts of data records, and the data records may have attributes associated with relatively large numbers of values. A data record can represent a respective event. One example attribute is a Drug attribute, which can have many values representing different drugs. Another example attribute is a Reaction attribute, which can have many values representing respective reactions to drugs.

Visualizing all of the possible categorical values of the Drug attribute and Reaction attribute that are found in a relatively large number of data records can result in a cluttered visualization, which can make it difficult for a user to identify which events represented in the visualization are more significant than other events that are visualized. For example, in the context of the Drug and Reaction attributes discussed above, it may be desirable to identify reactions to various drugs that are more significant than other reactions, so that an analyst can focus his or her analysis on the more significant reactions.

Once a visualization is provided of a relatively large number of events, a user may wish to zoom into a portion of the visualized data for a better understanding of the data. Traditionally, zooming into a portion of a visualization entails enlarging the zoomed in portion of the visualization. Although the visualized items may appear larger, the information presented to the user is generally the same.

In accordance with some implementations, a cell-based visualization is provided that can plot cells (also referred to as pixels) representing respective events at points on a visualization screen. A cell-based visualization according to some implementations allows a user to selectively perform different types of semantic focusing operations to better focus in on a selected region of the visualization. Each of the different types of semantic focusing operations provides further information regarding events represented by a selected region of cells in the visualization, with the different types of semantic focusing operations displaying different information. In some implementations, the different type of semantic focusing operations include a semantic zoom-in operation and a semantic drill-down operation.

A user can select a region of interest in the visualization, and the user can then perform different types of interactions to select different semantic focusing operations. For example, if a user applies a first type of interaction (e.g. a right click action on a pointer device), then a semantic zoom-in operation of the selected region can be performed. Alternatively, the user can apply a second type of interaction (e.g. a left click on the pointer device) to perform semantic drill-down of the selected region. Although reference is made to left and right clicks on a pointer device in some examples, it is noted that other types of user interactions can be made with respect to a visualization. For example, the different types of interactions can be touch-based interactions, such as with respect to a touch-sensitive display device or a touch pad. In such examples, different gestures made by the user can correspond to different types of interactions to select different semantic focusing operations.

A semantic zoom-in operation or a semantic drill-down operation causes a focus into the selected region that results in some change in the information that is presented. Semantic zoom-in causes cells representing the events of the selected region to be displayed with higher resolution (such as on a different scale), but using the same context (e.g. using the same set of attributes as displayed in the original visualization). Providing a higher resolution of a visual representation of events of the selected region provides an enlarged or expanded view of the events of the selected region.

In contrast, a semantic drill-down operation causes the events of the selected region to be displayed with a different set of attributes, so that the user can see different information as a result of the semantic drill-down operation. By presenting information of a different set of attributes, a different context is presented as a result of the semantic drill-down operation. In other words, not only does the semantic drill-down operation cause the resolution (e.g. scale) of the selected region to change, the semantic drill-down operation also causes the information presented to change.

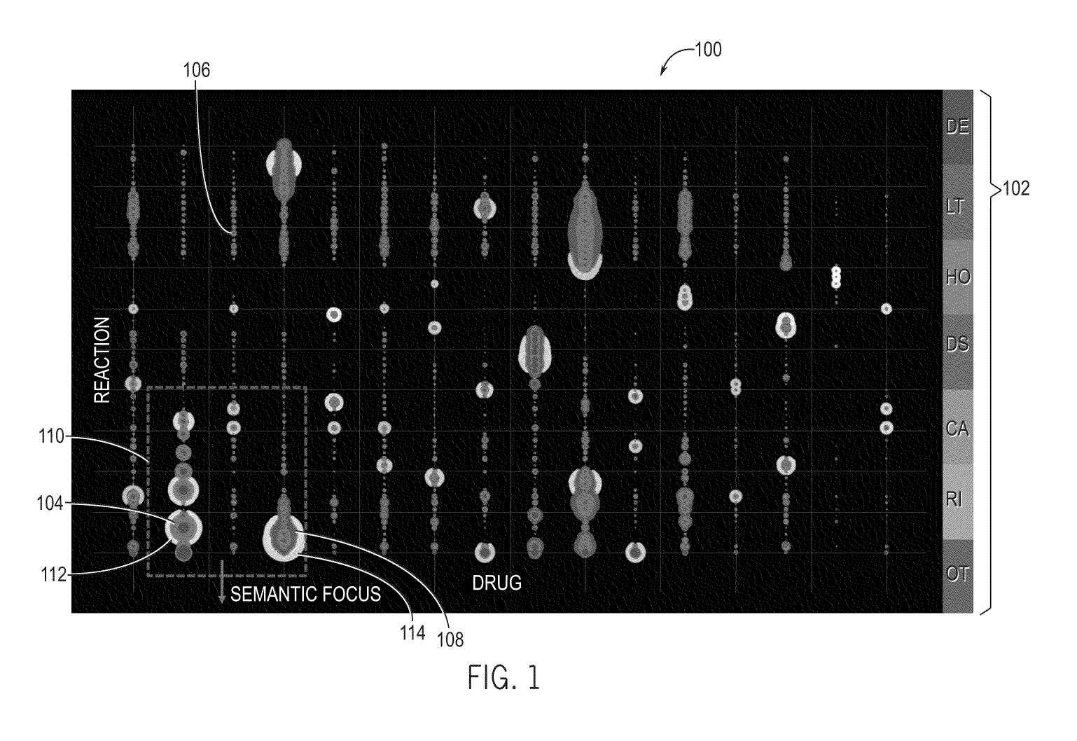

An example visualization screen 100 is shown in FIG. 1. The visualization screen 100 has a horizontal axis (x axis) and a vertical axis (y axis), which represent respective first and second attributes. The visualization screen 100 includes an x-y cell plane. In the example of FIG. 1, the x attribute is “Drug,” and they attribute is “Reaction.” A cell (or pixel) represents a respective event and corresponds to a respective pair of a value of the x attribute and a value of they attribute of the respective event. The cell is plotted at a position of the visualization screen 100 based on the value of the x attribute and the value of the y attribute in the respective data record.

A cell refers to a graphical element that is used for representing an event that corresponds to an x-y value pair. A cell can be in the form of a dot or graphical structure of any other shape. An event is expressed by a data record, and a data record can refer to any discrete unit of data that is received by a system. Each data record can have multiple attributes that represent different aspects of an event. For example, in the context of analysis relating to a drug trial, the events can include consumption of various different drugs by individuals, along with the corresponding reactions. The information collected in the drug trial can include reactions of the individuals to consumption of the drugs, as well as the corresponding outcomes. As an example, a data record can include the following attributes: Drug, Reaction, and Outcome (among other attributes). The Drug attribute can have multiple values that represent different drugs. The Reaction attribute can have different values that represent different reactions by individuals. The Outcome attribute can have multiple values that represent different outcomes associated with respective drug-reaction pairs.

The values of the Drug attribute can include drug names that identify different types of drugs that are the subject of analysis. Similarly, the values of the Reaction attribute and Outcome attribute can represent different reactions and different outcomes, respectively, associated with taking the drugs. In the visualization screen 100 of FIG. 1, an x coordinate represents the different values of the Drug attribute, while a y coordinate represents the different values of the Reaction attribute.

The cells in the graphical visualization 100 can also be assigned visual indicators (e.g. different colors, different gray scale indicators, different patterns, etc.) according to values of a third attribute (e.g. Outcome attribute that is different from the x and y attributes) in the respective data records. Different colors are assigned to the cells in FIG. 1 according to different values of the Outcome attribute.

A color scale 102 in the graphical visualization 100 maps different values of the Outcome attribute to different colors. In an example, the different values of the Outcome attribute can include the following: a DE value (which represents death as the outcome), an LT value (which represents a life-threatening condition as the outcome), an HO value (which represents hospitalization as the outcome), a DS value (which represents disability as the outcome), a CA value (which represents a congenital anomaly as the outcome), an RI value (which represents intervention as the outcome), and an OT value (which represents an “other” outcome). Although specific values of the Outcome attribute are shown in FIG. 1, it is noted that in other examples, other values of the Outcome attribute can be used.

Moreover, even though the example graphical visualization 100 depicts a visualization of the Drug attribute, Reaction attribute, and Outcome attribute, it is noted that the graphical visualization 100 can similarly be used for representing a relationship among other attributes in other examples.

More generally, cells representing events can be placed in the visualization screen 100 according to values of a subset of attributes (two or more attributes). Additionally, visual indicators are assigned to the cells based on an attribute, which can be one of the attributes in the subset, or an attribute that is in addition to the subset.

Several example clusters of cells are identified as 104, 106, and 108 in FIG. 1. The cluster 104 of cells includes cells assigned the red color (where the red color corresponds to the Outcome attribute having the DE value) and cells assigned the green color (where the green color corresponds to the HO value). The cells in the cluster 104 are plotted in a first region of the visualization screen 100.

The cluster 106 of cells include cells assigned the red color, cells assigned the green color, and cells assigned the brown color (which corresponds to the Outcome attribute having the OT value). The cells in the cluster 106 are plotted in a second region of the visualization screen 100.

The cluster 108 of cells include cells assigned the red color, cells assigned the green color, and cells assigned the brown color. The cells in the cluster 108 are plotted in a third region of the visualization screen 100.

The size of each group of cells indicates a number of events represented by the group.

FIG. 1 also shows a region 110 of the visualization 100 that has been selected by a user. The region 110 is referred to as a “focus region,” since the user has selected the region 110 for performing a semantic focusing operation. In an example, the user can use a pointer device to perform a rubber-band operation to select the rectangular box that corresponds to the region 110. Alternatively, the region 110 can be selected using a different type of input, such as a touch-sensitive input (e.g. input on a touch-sensitive display device or a touch pad).

Once the focus region 110 is selected, the user can perform one of multiple different types of interactions to perform respective different semantic focusing operations, including a semantic zoom-in operation or a semantic drill-down operation, as discussed above.

In examples according to FIG. 1, a significance visual indicator is associated with each of the clusters 104 and 108 of cells. A significance visual indicator 112 is associated with the cluster 104 of cells, while a significance indicator 114 is associated with the cluster 108 of cells. However, a significance visual indicator is not associated with the cluster 106 of cells.

In some implementations, each significance visual indicator includes a ring having a brightness that is based on the corresponding degree of significance of the corresponding group of cells. The ring surrounds the respective cluster of cells. For example, the ring 112 surrounds the cluster 104 of cells, while the ring 114 surrounds a portion of the cluster 108 of cells. The degree of significance of a cluster of cells can be indicated by a value of a significance metric that represents a statistical significance of the cluster of cells. In some examples, a statistical significance can refer to significance that is computed based on relative distributions of events having corresponding attribute values. Examples of computing the degree of significance of a cluster of cells are described in U.S. application Ser. No. 13/745,985, entitled “VISUALIZATION THAT INDICATES EVENT SIGNIFICANCE REPRESENTED BY A DISCRIMINATIVE METRIC COMPUTED USING A CONTINGENCY CALCULATION,” filed Jan. 21, 2013.

The degree of brightness of the significance visual indicator is adjusted based on the value of the significance metric. A cluster of cells associated with a higher significance is assigned a significance visual indicator of greater brightness, whereas a cluster of cells associated with lower significance is assigned a visual indicator having reduced brightness.

In other examples, instead of using rings, other types of graphical elements can be used as significance visual indicators. In yet further examples, the significance visual indicators can be omitted.

In the visualization screen 100, a cluster of cells (e.g. cluster 104 or 106 in FIG. 1) can correspond to events that share a common pair of values of the x attribute and y attribute (in other words, share the same x-y value pair). Although reference is made to events that share a particular pair of attribute values, it is noted that in other implementations, events can share a collection of values of more than two attributes.

Traditionally, points that represent events that share the same x-y value pair may be plotted at the same position in a visualization screen, which results in occlusion (due to overlay) of the multiple points representing the events sharing the same x-y value pair. In contrast, in accordance with some implementations, instead of plotting cells representing events that share the same x-y value pair at the same position in the graphical visualization 100, the cells are placed at different nearby positions close to each other (around a point that corresponds to the shared x-y value pair), to form a cluster of the cells representing the events sharing the same x-y value pair. The cells in this cluster are placed in a respective region of the graphical visualization 100, where the region can have a circular shape, an oval shape, an ellipsoid shape, or any other shape.

Within each region, the cells are sorted according to the values of the third attribute (which in the example is the Outcome attribute). Sorting the cells of a region refers to placing the cells in the region according to the values of the third attribute. By performing the sorting, cells are positioned in proximity to each other according to the values of the third attribute, such that cells that share or have relatively close values of the third attribute are placed closer to each other than cells that have greater differences in the values of the third attribute.

The sorting allows sub-groups of cells to be formed within a cluster. Thus, for example, in cluster 104 in FIG. 1, a first sub-group includes the cells assigned the red color, while a second sub-group includes cells assigned the green color. The cells assigned the green color in the group 104 are placed around the cells assigned the red color. By sorting the cells such that respective sub-groups are visible, a user can more easily determine the relative amounts of cells assigned to different values of the third attribute.

Although the various clusters of cells depicted in the graphical visualization 100 of FIG. 1 are for the most part placed in discrete regions that do not overlap each other, there can be instances where large amounts of data records at neighboring x-y value pairs may result in some overlap of cells for different x-y value pairs. The cluster 108 is an example of a cluster that has overlapping regions. The cluster 108 includes overlapping regions corresponding to a first drug, and multiple reactions.

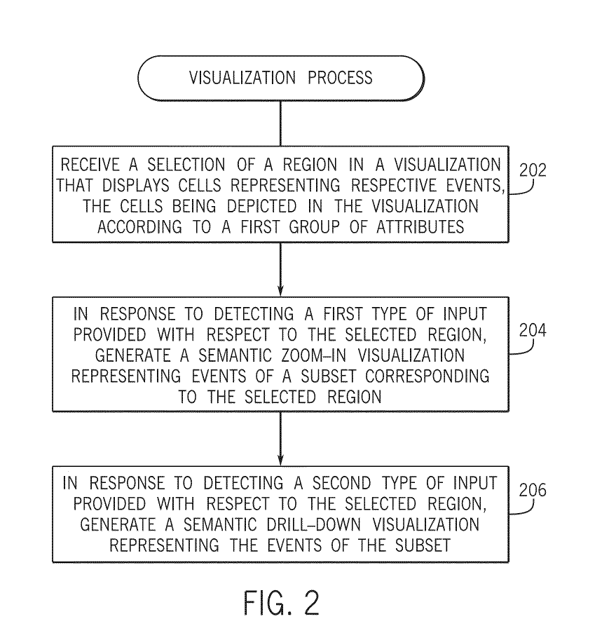

FIG. 2 is a flow diagram of a visualization process according to some implementations, for visualizing events expressed by data records that each includes multiple attributes. The multiple attributes can include an x attribute and a y attribute for positioning cells in a visualization, and a coloring attribute to assign colors to cells. The visualization process receives (at 202) a selection of a region (e.g. focus region 110 in FIG. 1) in a visualization (e.g. visualization 100) that displays cells representing respective events. The cells are depicted in the visualization according to a first group of attributes of the events. For example, this first group of attributes can include the Drug attribute, Reaction attribute, and Outcome attribute depicted in FIG. 1.

In response to detecting a first type of input provided with respect to the selected region, the visualization process generates (at 204) a semantic zoom-in visualization of the selected region. The semantic zoom-in visualization is produced by the semantic zoom-in operation discussed above, where the semantic zoom-in visualization depicts the cells representing the events of the subset of the selected region according to the first group of attributes, including the selected Drug attribute, selected Reaction attribute, and Outcome attribute in the focus region 110.

In generating the semantic zoom-in visualization, the scale is enlarged as compared to the original visualization. Enlarging the scale refers to increasing the visualized area corresponding to given ranges of x and y attribute values. For example, in the original visualization, a first area is used to represent a first range of x attribute values and a second range of y attribute values. In the semantic zoom-in visualization, the scale is enlarged by using a second area that is larger than the first area to represent the first range of x attribute values and the second range of y attribute values.

In addition to enlarging the scale in the semantic zoom-in visualization, positions of cells sharing the same x-y value pair are also adjusted. In accordance with some implementations, instead of plotting cells representing events that share the same x-y value pair at the same position in the semantic zoom-in visualization, the cells are placed at different nearby positions close to each other (around a coordinate that corresponds to the shared x-y value pair), to form a cluster of the cells representing the events sharing the same x-y value pair, to avoid overlay of such cells.

In response to detecting a second type of input provided with respect to the selected region, the visualization process generates (at 206) a semantic drill-down visualization of the selected region. The semantic drill-down visualization is produced by the semantic drill-down operation discussed above, and the semantic drill-down visualization visualizes the events of the subset according to a second group of attributes having at least one attribute that differs from the attributes of the first group.

In generating the semantic drill-down visualization, the scale is enlarged, and positions of cells sharing the same x-y value pair can also be adjusted to avoid overlay.

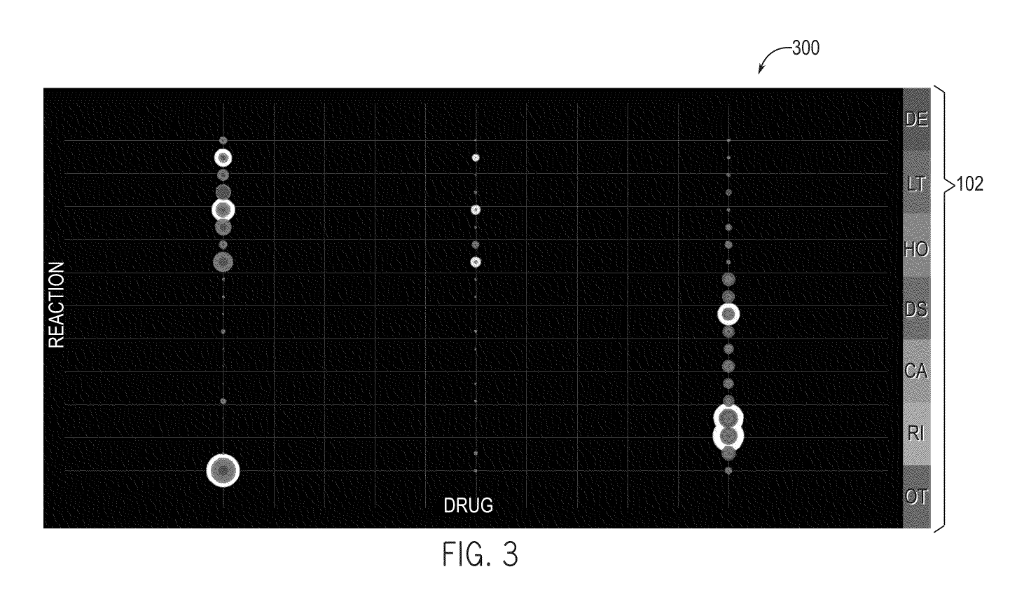

FIG. 3 depicts an example of a semantic zoom-in visualization 300, which is produced in response to a first type of input (e.g. right click by a user of a pointer device) made with respect to the selected region 110 in FIG. 1. Note that the attributes depicted by the semantic zoom-in visualization 300 are the same attributes as in the visualization screen 100, namely the Drug attribute, Reaction attribute, and Outcome attribute, but at an enlarged scale.

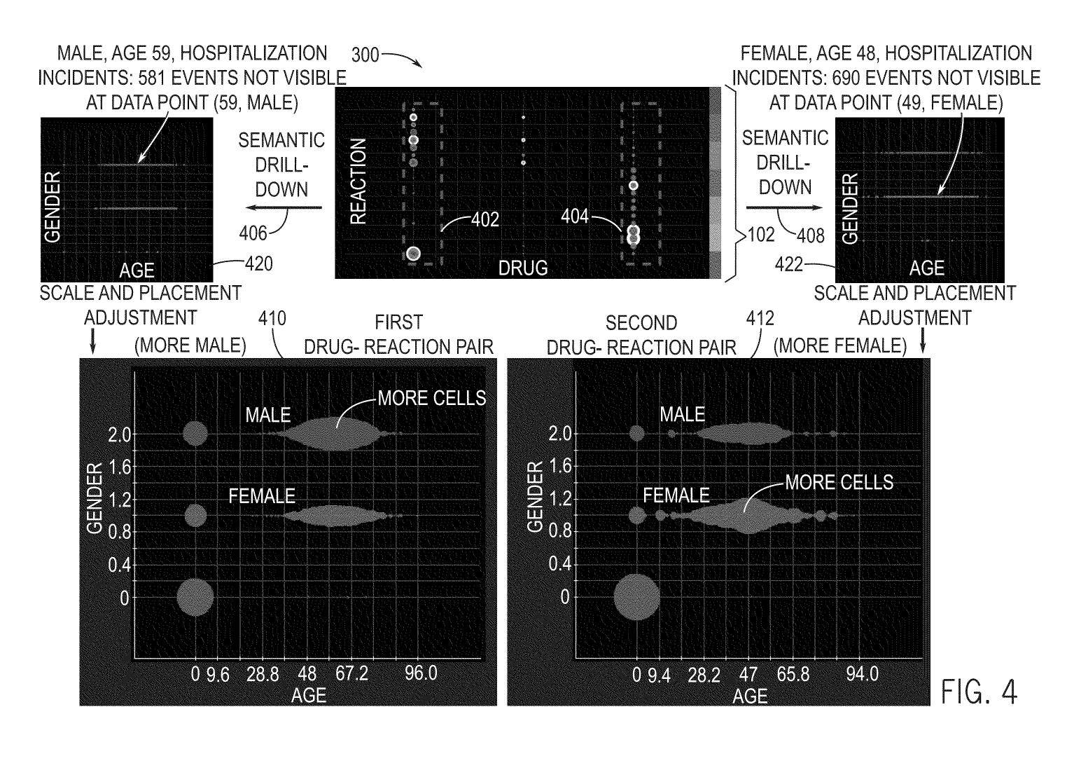

FIG. 4 depicts a further example, in which regions 402 and 404 have been selected in the semantic zoom-in visualization 300. Two different semantic drill-down operations (406 and 408) are performed in response to a second type of input made by the user with respect to each of the selected regions 402 and 404. The semantic drill-down operation 406 produces an intermediate semantic drill-down visualization 420, which includes cells corresponding to a different set of attributes pertaining to a first drug-reaction combination. In the intermediate visualization 420, the x axis represents the Age attribute, while they axis represents the Gender attribute. In the visualization 420, the red cells represent events that correspond to male participants, while the purple cells represent events that correspond to female participants. The brown cells represent events for which the gender of participants cannot be determined.

Since there are a relatively large number of cells representing events that share common values of the Age and Gender attributes in the intermediate visualization 420, there can be overlapping of cells. For example, a group of cells that share a particular pair of values of the Age and Gender attributes may be mapped to the same coordinate in the intermediate visualization 420, which means that the cells in the group will overlap each other so that a viewer would not be able to easily determine how many events are represented.

In accordance with some implementations, the positions of cells in the group that represent events that share the particular pair of values of the Age and Gender attributes can be adjusted, such that the cells in the group are positioned at nearby positions around a coordinate corresponding to the shared pair of values of the Age and Gender attributes. The repositioning of the cells that share common values of the Age and Gender attributes produces a final semantic drill-down visualization 410, which includes the cells of the intermediate semantic drill-down visualization 420 that have been repositioned to avoid overlay of cells that share the common attribute values. In the visualization 410, the x axis represents the Age attribute, while they axis represents the Gender attribute. In the visualization 410, the red cells represent events that correspond to male participants, while the purple cells represent events that correspond to female participants. The repositioning of cells in the final visualization 410 results in respective larger clusters of red, purple, and brown cells to avoid overlay of cells sharing common attribute values, where the size of each cluster indicates a number of events represented by the cluster. In the visualization 410, it can be determined that there are a larger number of events involving male participants for the first drug-reaction pair represented by the visualization 410.

The semantic drill-down operation 408 produces another intermediate semantic drill-down visualization 422, which includes cells representing an Age attribute and a Gender attribute. The visualization 422 represents a second drug-reaction combination. Overlay of cells representing events sharing common attribute values also occurs in the intermediate semantic drill-down visualization 422. Repositioning of cells sharing common attribute values can be performed to generate a final semantic drill-down visualization 412, which includes larger clusters of cells representing an Age attribute and a Gender attribute. It can be seen from the visualization 412 that there are more events involving female participants than male participants.

Since the semantic drill-down visualizations 410 and 412 are produced by semantic drill-down operations 406 and 408 from the semantic zoom-in visualization 300, which in turn is produced by a semantic zoom-in operation from the visualization 100 of FIG. 1, the semantic drill-down operations 406 and 408 can be referred to as recursive semantic drill-down operations. The semantic drill-down visualizations 410 and 412 can be referred to as recursive drill-down visualizations.

Repositioning of cells that share common attribute values can also be performed in producing the semantic zoom-in visualization 300 of FIG. 3. In the semantic zoom-in visualization 300, cells sharing a common x-y value pair are placed in nearby positions to form respective clusters of cells in the semantic zoom-in visualization 300, similar to the technique used in the visualization 100. Placing cells sharing a common x-y value pair in nearby positions avoids overlaying of the cells.

In addition to repositioning cells to avoid overlay, scale adjustment is also performed. The scales of the final semantic drill-down visualizations 410 and 412 are enlarged from the scales of the intermediate semantic drill-down visualizations 420 and 422, to allow for clearer viewing of the cells in the final semantic drill-down visualizations 420 and 422.

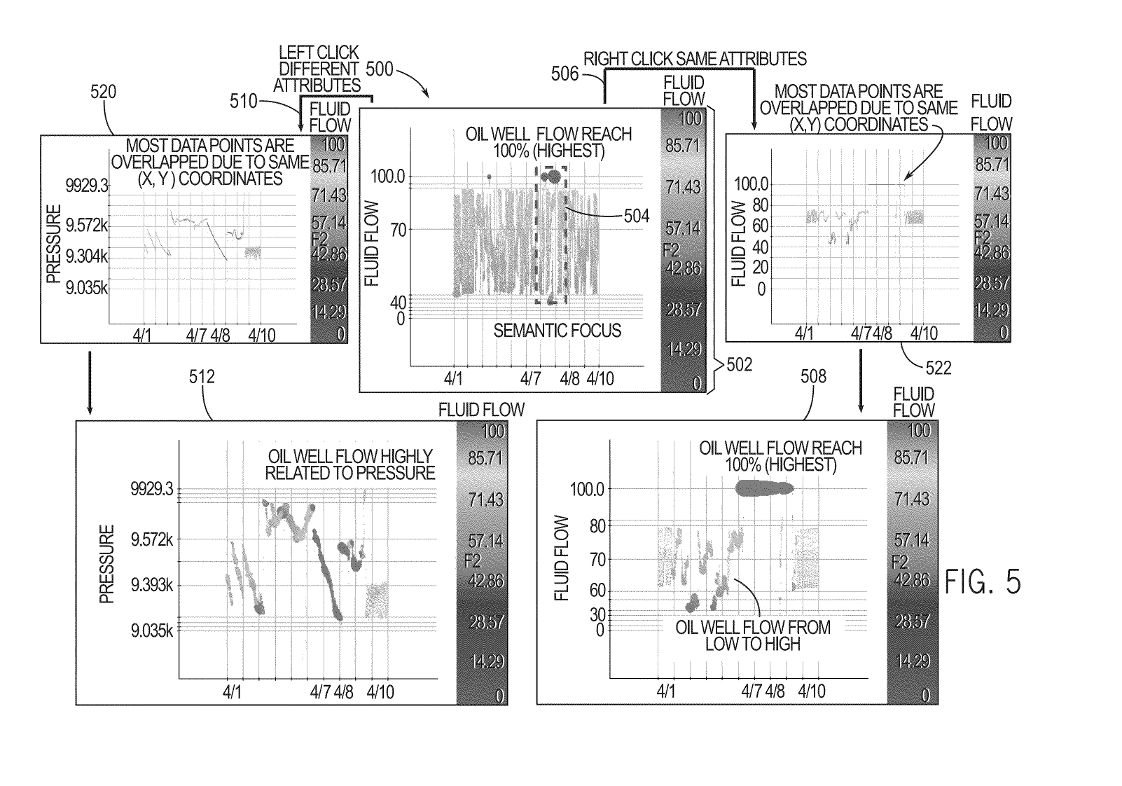

FIG. 5 illustrates a different example. In FIG. 5, a cell-based visualization screen 500 includes cells representing events corresponding to production of fluids from a well from a subterranean structure. In the visualization screen 500, the x axis represents a Date attribute, whereas they axis represents a Fluid Flow attribute. The colors assigned to the cells, according to a color scale 502, is based on values of the Fluid Flow attribute.

A focus region 504 can be selected in the visualization 500, on which a semantic focus operation can be applied. A first type of input (e.g. right click) causes a semantic zoom-in operation to be performed, which generates an intermediate semantic zoom-in visualization 522. The semantic zoom-in visualization 522 is an enlarged visualization of the cells in the selected focus region 504 in the same context (using the same set of attributes) as the original visualization screen 500. However, overlaying of cells representing events sharing common attribute values is present in the intermediate zoom-in visualization 522. To avoid such overlay, positions of the cells sharing common attribute values can be adjusted to nearby positions around a coordinate corresponding to each shared pair of common attribute values, to produce a final semantic zoom-in visualization 508. Also, scale enlargement is performed such that the scale of the final zoom-in visualization 508 is larger than the scale of the intermediate zoom-in visualization 522.

A second type of input (e.g. left click) on the selected region 504 causes a semantic drill-down operation 510, which generates an intermediate semantic drill-down visualization 520. The intermediate semantic drill-down visualization 520 depicts different attributes of the events in the selected region 504. In the example of FIG. 5, the intermediate semantic drill-down visualization 520 depicts cells according to the following attributes: Date, Pressure, and Fluid Flow. More specifically, the x axis of the visualization 520 represents the Date attribute, they axis represents the Pressure attribute, while the colors of the cells are assigned based on values of the Fluid Flow attribute.

Overlaying of cells representing events sharing common attribute values can occur in the intermediate semantic drill-down visualization 520. Adjustment of positions of such cells can be performed to avoid overlay, to produce a final semantic drill-down visualization 512. Also, the final semantic drill-down visualization 512 is enlarged from the intermediate semantic drill-down visualization 520.

By using techniques or mechanisms according to some implementations, flexibility is provided to users to focus on regions of interest in visualizations. Different types of user inputs causes corresponding different semantic focusing operations to be performed. Moreover, recursive semantic focusing operations can be triggered from a semantically focused visualization (e.g. semantic zoom-in visualization or semantic drill-down visualization).

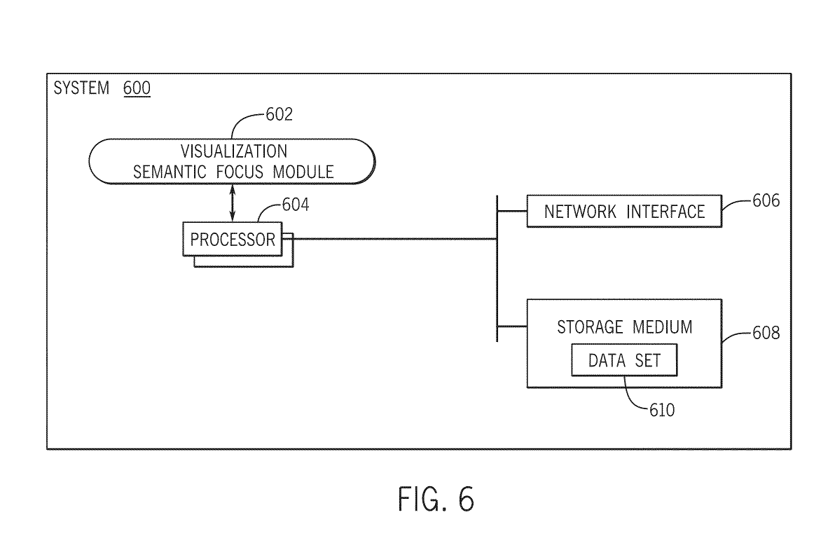

FIG. 6 is a block diagram of an example system 600 that has a visualization semantic focus module 602 according to some implementations, which can perform various tasks discussed above, including those tasks depicted in FIG. 2. The visualization semantic focus module 602 can perform different types of semantic focusing operations in response to different types of inputs made with respect to a selected focus region. The visualization semantic focus module 602 can produce visualization screens according to some implementations, such as those depicted in FIGS. 1 and 3-5.

The visualization semantic focus module 602 can be implemented as machine-readable instructions executable on one or multiple processors 604. A processor can include a microprocessor, microcontroller, processor module or subsystem, programmable integrated circuit, programmable gate array, or another control or computing device. The processor(s) 604 can be connected to a network interface 606 and a storage medium (or storage media) 608. The storage medium (storage media) 608 can store a dataset 610 (containing data records) that has been received by the system 600.

The storage medium (or storage media) 608 can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, by a system including a processor, a selection of a region in a visualization that displays cells representing respective events, the cells being depicted in the visualization according to a first group of attributes of the events, wherein the region corresponds to a subset of the events;
in response to detecting a first type of input provided with respect to the region, generating, by the system, a semantic zoom-in visualization of the region, the semantic zoom-in visualization depicting the cells representing the events of the subset at an enlarged scale and according to the first group of attributes; and
in response to detecting a second type of input provided with respect to the region, generating, by the system, a semantic drill-down visualization of the region, the semantic drill-down visualization visualizing the events of the subset at an enlarged scale and according to a second group of attributes having at least one attribute that differs from the attributes of the first group,
wherein generating the semantic zoom-in visualization or the semantic drill-down visualization includes adjusting positions of cells sharing common attribute values.

2. The method of claim 1, wherein the first type of input is a first type of user input, and the second type of input is a second type of user input.

3. The method of claim 1, further comprising causing display of the visualization that has a horizontal axis corresponding to a first of the attributes in the first group, and a vertical axis corresponding to a second of the attributes in the first group, the method further comprising:
assigning visual indicators to the cells in the visualization according to values of a third of the attributes in the first group.

4. The method of claim 1, further comprising:
receiving a further input with respect to a region of the semantic zoom-in visualization; and
in response to the further input, generating a recursive semantic drill-down visualization of the region of the semantic zoom-in visualization.

5. The method of claim 1, wherein adjusting the positions of cells sharing common attribute values in the semantic zoom-in visualization comprises placing cells sharing a given set of values of a subset of attributes of the first group to avoid overlaying the cells sharing the given set of values, wherein placing the cells sharing the given set of values forms a cluster of cells in the semantic zoom-in visualization.

6. The method of claim 5, further comprising:
sorting the cluster of cells sharing the given set of values of the subset of attributes according to respective values of another attribute in the first group.

7. The method of claim 5, wherein a size of the cluster of cells represents a number of events represented by the cells of the cluster.

8. The method of claim 1, wherein adjusting the positions of cells sharing common attribute values in the semantic drill-down visualization comprises placing cells sharing a given set of values of a subset of attributes of the second group to avoid overlaying the cells sharing the given set of values, wherein placing the cells sharing the given set of values forms a cluster of cells in the semantic drill-down visualization.

9. An article comprising at least one machine-readable storage medium storing instructions that upon execution cause a system to:
cause display of a first visualization that displays cells representing respective events, the cells being depicted in the first visualization according to a first group of attributes of the events;
receive user selection of a region in the first visualization, the region corresponding to a subset of the events;
in response to a first type of user input provided with respect to the region, generate a semantic zoom-in visualization of the region, the semantic zoom-in visualization depicting the cells representing the events of the subset at an enlarged scale and according to the first group of attributes; and
in response to a second type of user input provided with respect to the region, generate a semantic drill-down visualization of the region, the semantic drill-down visualization visualizing the events of the subset at an enlarged scale and according to a second group of attributes having at least one attribute that differs from the attributes of the first group,
wherein generating the semantic zoom-in visualization or the semantic drill-down visualization includes adjusting positions of cells sharing common attribute values.

10. The article of claim 9, wherein the instructions upon execution cause the system to further assign colors to the cells in the first visualization according to a coloring attribute from the first group.

11. The article of claim 10, wherein the instructions upon execution cause the system to further assign colors to the cells in the semantic zoom-in visualization according to the coloring attribute.

12. The article of claim 11, wherein the instructions upon execution cause the system to further assign colors to the cells in the semantic drill-down visualization according to an attribute of the second group.

13. The article of claim 9, wherein adjusting the positions of cells sharing common attribute values in the semantic zoom-in visualization and in the semantic drill-down visualization is to avoid cell overlay.

14. A computer system comprising:
at least one processor to:
receive a selection of a region in a visualization that displays cells representing respective events, the cells being placed and assigned visual indicators in the visualization according to a first group of attributes of the events, wherein the region corresponds to a subset of the events;
in response to detecting a first type of input provided with respect to the region, generate a semantic zoom-in visualization of the region, the semantic zoom-in visualization depicting the cells representing the events of the subset at an enlarged scale and according to the first group of attributes and at a higher resolution to show further information relating to the events of the subset; and
in response to detecting a second type of input provided with respect to the region, generate a semantic drill-down visualization of the region, the semantic drill-down visualization visualizing the events of the subset at an enlarged scale and according to a second group of attributes having at least one attribute that differs from the attributes of the first group,
wherein generating the semantic zoom-in visualization or the semantic drill-down visualization includes adjusting positions of cells sharing common attribute values.

15. The computer system of claim 14, wherein the assigned visual indicators are colors.
